(19) United States
(12) Patent Application Publication
(10) Pub. No.: US 2025/0348363 A1
(43) Pub. Date: Nov. 13, 2025

(54) METHOD FOR SCHEDULING TASKS IN CLOUD ENVIRONMENT AND APPARATUS THEREFOR

(71) Applicant: SAMSUNG SDS CO., LTD., Seoul (KR)

(72) Inventors: Youngil JUNG, Seoul (KR); Soonhong YOON, Seoul (KR); Younghoon AHN, Seoul (KR); Subin KIM, Seoul (KR); Hosang YOON, Seoul (KR)

(73) Assignee: SAMSUNG SDS CO., LTD., Seoul (KR)

(21) Appl. No.: 19/203,324

(22) Filed: May 9, 2025

(30) Foreign Application Priority Data
May 13, 2024 (KR) 10-2024-0062783
Sep. 2, 2024 (KR) 10-2024-0118287

(51) Int. Cl. G06F 9/50; G06F 9/48; G06F 40/284

(52) U.S. Cl. CPC G06F 9/5044; G06F 9/4881; G06F 9/505; G06F 40/284; G06F 2209/501

(57) ABSTRACT

The disclosure relates to a method for scheduling tasks related to artificial intelligence (AI) services in a multi-GPU-based cloud environment, and the method includes: collecting information about a plurality of nodes in a cluster of a cloud environment; obtaining, from a user terminal, a task related to an AI service provided by the cluster; detecting a plurality of indicator data for scheduling the task; and selecting a node to assign the task among the plurality of nodes using the plurality of indicator data.

### CROSS-REFERENCE TO RELATED APPLICATIONS

This application claims priority to Korean Patent Application No. 10-2024-0062783 filed on May 13, 2024 and Korean Patent Application No. 10-2024-0118287 filed on Sep. 2, 2024, in the Korean Intellectual Property Office, the entire contents of which are hereby incorporated by reference in its entirety.

### BACKGROUND OF THE INVENTION

### 1. Field of the Invention

The disclosure relates to load balancing technology and, more specifically, to a method and apparatus for scheduling tasks related to artificial intelligence (AI) services in a multi-GPU-based cloud environment.

### 2. Description of the Prior Art

Cloud service providers such as AWS, Azure, and GCP provide services of distributing foundation models and large language models (LLMs) fine-tuned by users as API (application programming interface) endpoints, based on their own serving engines. Since LLM inference utilizes expensive graphics processing units (GPUs), cloud service providers are developing cloud service provider systems in consideration of indicators such as GPU utilization, fast response processing to user queries, the maximum number of concurrent users, and token processing volume.

In a multi-GPU-based cloud environment, load distribution (or load balancing) technology is required to appropriately distribute the load to the nodes in order to efficiently manage the resources of nodes in the cluster and ensure the service level objectives (SLO).

One of the representative existing load distribution algorithms is the round-robin (RR) method. The round-robin method is a technique for evenly distributing tasks (i.e., loads) related to AI services to nodes. However, the round-robin method evenly distributes tasks related to AI services to the respective nodes, but does not consider the difficulty of the tasks, so there is a problem in which service delays occur in nodes that are assigned tasks with high difficulty. In particular, in LLM serving, the gap between high-performance hardware and low-performance hardware widens as the task difficulty increases. To solve this problem, a method is needed to effectively schedule tasks related to AI services in a multi-GPU-based cloud environment.

### SUMMARY OF THE INVENTION

The disclosure aims to solve the aforementioned problems and other problems. The disclosure is to provide a method and apparatus for effectively scheduling tasks related to AI services, based on task difficulty and/or node-specific status information in a multi-GPU based cloud environment.

According to an aspect of the disclosure, there is provided a task scheduling method including: collecting information about a plurality of nodes in a cluster of a cloud environment; obtaining, from a user terminal, a task related to an artificial intelligence (AI) service provided by the cluster; detecting a plurality of indicator data for scheduling the task; and selecting a node to assign the task among the plurality of nodes using the plurality of indicator data.

According to another aspect of the disclosure, there is provided a task scheduling apparatus including at least one processor configured to execute a plurality of instructions to perform a plurality of operations and at least one memory configured to store the plurality of instructions, wherein the plurality of operations comprises: collecting information about a plurality of nodes in a cluster of a cloud environment; obtaining, from a user terminal, a task related to an artificial intelligence (AI) service provided by the cluster; detecting a plurality of indicator data for scheduling the task; and selecting a node to assign the task among the plurality of nodes using the plurality of indicator data.

According to another aspect of the disclosure, there is provided a computer-readable storage medium storing one or more programs for performing a task scheduling process by one or more processors of a computing device, and the one or more programs include instructions for: collecting information about a plurality of nodes in a cluster of a cloud environment; obtaining, from a user terminal, a task related to an artificial intelligence (AI) service provided by the cluster; detecting a plurality of indicator data for scheduling the task; and selecting a node to assign the task among the plurality of nodes using the plurality of indicator data.

### BRIEF DESCRIPTION OF THE DRAWINGS

The attached drawings are included as part of the detailed description to help understanding of the disclosure and explain embodiments and technical features of the disclosure along with the detailed description.

FIG. 1 is a drawing illustrating the configuration of a cloud service provider system according to an embodiment of the disclosure.

FIG. 2 is a block diagram of a task scheduling apparatus according to an embodiment of the disclosure.

FIG. 3 is a drawing illustrating multiple pieces of indicator data required for task scheduling.

FIG. 4 is a drawing illustrating task difficulty scores according to an input token size and a GPU configuration for each node.

FIG. 5 is a drawing illustrating multiple indicator values according to the GPU configuration for each node.

FIG. 6 is a drawing illustrating indicator values normalized through a normalization function.

FIG. 7 is a drawing illustrating indicator values of a specific node and weights for respective indicators.

FIGS. 8A to 8D are a drawing illustrating a method of configuring weights differently depending on scenarios.

FIG. 9 is a flowchart illustrating a task scheduling method according to an embodiment of the disclosure.

FIG. 10 is a block diagram of a computing device according to an embodiment of the disclosure.

### DETAILED DESCRIPTION OF THE EXEMPLARY EMBODIMENTS

Hereinafter, the embodiments disclosed in this specification will be described in detail with reference to the attached drawings. Regardless of reference numerals, identical or similar components will be assigned the same reference numbers and redundant descriptions thereof will be omitted. The terms “module” and “unit” used for components in the following description are assigned or used interchangeably in consideration of the ease of drafting the specification, and do not have distinct meanings or roles in themselves. That is, the term “unit” used in the disclosure indicates software or a hardware element such as FPGA or ASIC, and the “unit” performs a certain role. However, the “unit” is not limited to software or hardware. The “unit” may be configured to reside in an addressable storage medium or may be configured to reproduce one or more processors. Accordingly, as an example, “units” include elements such as software elements, object-oriented software elements, class elements, and task elements, processes, functions, properties, procedures, subroutines, segments of program code, drivers, firmware, microcode, circuits, data, databases, data structures, tables, arrays, and variables. The functions provided by the elements and “units” may be combined into a smaller number of elements and “units” or may be further divided into additional elements and “units”.

In addition, in describing the embodiments disclosed in this specification, a detailed description of a related known technology, which may obscure the subject matter of the embodiments disclosed in this specification, will be omitted. In addition, the attached drawings are only intended to facilitate easy understanding of the embodiments disclosed in this specification, and the technical ideas disclosed in this specification are not limited to the attached drawings, and should be understood to include all modifications, equivalents, or substitutes included in the scope of the disclosure.

The disclosure proposes a method and apparatus for effectively scheduling tasks related to AI services, based on task difficulty and/or node-specific status information in a multi-GPU-based cloud environment.

Hereinafter, various embodiments of the disclosure will be described in detail with reference to drawings.

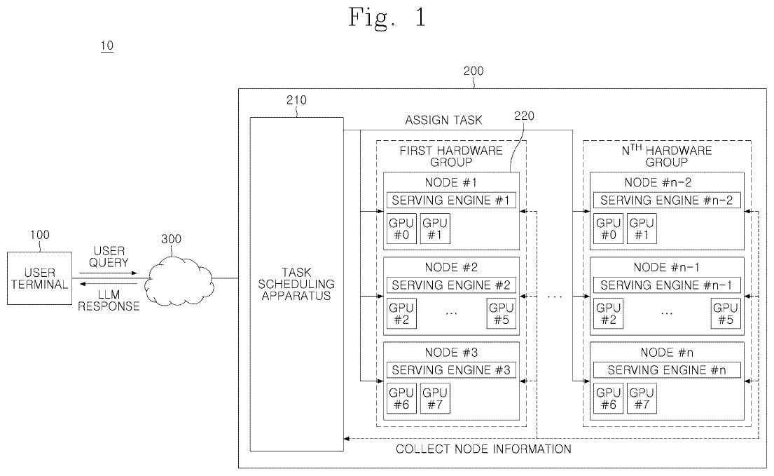

FIG. 1 is a drawing illustrating the configuration of a cloud service provider system according to an embodiment of the disclosure.

Referring to FIG. 1, a cloud service provider system 10 according to an embodiment of the disclosure may include a user terminal 100, a cloud service provider server 200, and a communication network 300.

The user terminal 100 and the cloud service provider server 200 may be connected to each other through the communication network 300. The communication network 300 may include a wired network and a wireless network, and specifically, may include various networks such as a local area network (LAN), a metropolitan area network (MAN), and a wide area network (WAN). Additionally, the communication network 300 may include the well-known World Wide Web (WWW). However, the communication network 300 according to the disclosure is not limited to the networks listed above, and may include at least one of the known wireless data network, the known telephone network, and the known wired/wireless television network.

The user terminal 100 may provide a cloud service by linking with the cloud service provider server 200. In this case, the cloud service may include an artificial intelligence (AI) service based on a large language model (LLM).

The user terminal 100 may provide the user's query data to the cloud service provider server 200. The user terminal 100 may receive LLM response data corresponding to the user's query data from the cloud service provider server 200.

The user terminal 100 described in this specification may include, but is not necessarily limited to, a mobile phone, a smartphone, a laptop computer, a desktop computer, a digital broadcasting terminal, a PDA (personal digital assistant), a PMP (portable multimedia player), a slate PC, a tablet PC, an ultra-book, a wearable device, and the like.

The cloud service provider server 200 may provide a cloud service to the user terminal 100. The cloud service provider server 200 may be a type of cluster.

The cloud service provider server 200 may generate a response to a user query in units of tokens using an LLM model implemented through a container, and may provide the response generated in units of tokens to the user terminal 100 in a streaming manner.

The cloud service provider server 200 may include a task scheduling apparatus 210 and multiple nodes 220. Here, the multiple nodes 220 may be classified into multiple hardware groups according to the performance of the graphics processing unit (GPU).

Each node 220 may include a serving engine and one or more graphics processing units (GPUs). Here, the serving engine is an engine for providing an LLM model. The serving engine may be implemented on a container.

The task scheduling apparatus 210 may perform a function of allocating a task to an optimal node 220, based on the difficulty of the task requested by the user terminal 100 and node-specific status information in the cluster. Here, the difficulty of a task may correspond to the length of the user query data. The node-specific status information may include status information of the GPU and status information of the serving engine.

The higher the difficulty of a task requested by the user (i.e., the longer the user query), the more the task is scheduled to be processed on a node with higher performance computing power, and the lower the difficulty of a task requested by the user (i.e., the shorter the user query), the more the task is scheduled to be processed on a node with lower performance computing power. In other words, in order to efficiently use limited resources, it is advantageous in terms of resource utilization to process the task with higher difficulty on high-performance hardware. However, if only the difficulty of the task is used as a variable, a phenomenon in which the load is concentrated on a specific node may occur. Therefore, this may be prevented by utilizing the node-specific status information as an additional variable.

The cloud service provider server 200 may efficiently manage the resources of nodes in the cluster through a new load balancing technology rather than the existing round-robin method, and may also stably attain the service level objectives (SLOs). Here, the service level objectives (SLOs) may include a time-to-first token (TTFT) and a time-per-output token (TPOT). The TTFT indicates the time required for the LLM model to output a token generated first (i.e., a first token) to the user terminal 100, and the TPOT indicates the average time required between tokens generated consecutively after the first token in the LLM model.

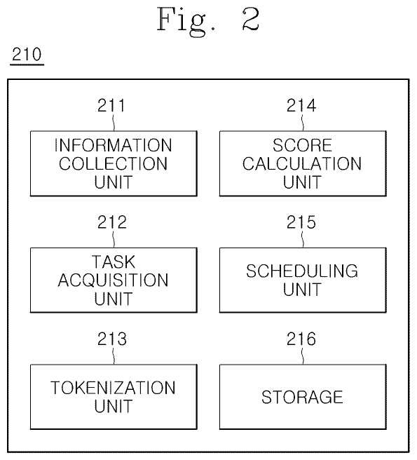

FIG. 2 is a block diagram of a task scheduling apparatus according to an embodiment of the disclosure.

Referring to FIG. 2, a task scheduling apparatus 210 according to an embodiment of the disclosure may include an information collection unit 211, a task acquisition unit 212, a tokenization unit 213, a score calculation unit 214, a scheduling unit 215, and a storage 216. The components illustrated in FIG. 2 are not essential for implementing the task scheduling apparatus, so the task scheduling apparatus described in this specification may include more or fewer components than the components listed above.

The information collection unit 211 may collect information about multiple nodes that constitute a cluster of a cloud environment.

For example, the information collection unit 211 may collect information about the types, performance, and quantity of GPUs included in each node.

The information collection unit 211 may periodically collect metric information (or metric data) related to GPUs included in each node. Here, the metric information related to GPUs may include GPU utilization.

The information collection unit 211 may periodically collect metric information related to the serving engine included in each node. Here, the metric information related to the serving engine may include at least one of an average prefill response time, an average decode response time, a queue size, and a batch size.

LLM serving is largely configured as a prefill stage and a decode (token generation) stage. Here, the prefill stage performs a multiplication operation of a matrix and a matrix, and the decode stage performs a multiplication operation of a matrix and a vector, so the prefill stage is more hardware-dependent than the decode stage. That is, the prefill stage performs a computing-intensive operation, while the decode stage performs a memory-intensive operation.

The average prefill response time indicates the average time required for the attention operation for the entire relationship of the input tokens, and the average decode response time indicates the average time required for the attention operation for the output tokens. In addition, the batch size indicates the number of inference requests capable of being processed at once by the LLM model, and the queue size indicates the number of inference requests capable of waiting before entering the batch.

Among the metric information related to the serving engine, the average prefill response time and the queue size are closely related to the TTFT of the service level objectives (SLOs), and the average decode response time and the batch size are closely related to the TPOT of the service level objectives (SLOs).

The information collection unit 211 may store collected information about the multiple nodes in the storage 216.

The task acquisition unit 212 may acquire, from the user terminal 100, a task related to the AI service, that is, query data requested by the user. The task acquisition unit 212 may provide the user query data acquired from the user terminal 100 to the tokenization unit 213. In addition, the task acquisition unit 212 may store the user query data acquired from the user terminal 100 in the storage 216.

The tokenization unit 213 may tokenize the user query data (i.e., query text). Here, tokenization indicates an operation of dividing the given text into small units called tokens.

The tokenization unit 213 may detect an input token size (i.e., number of input tokens) generated through the above tokenization process. The tokenization unit 213 may store information about the detected the input token size in the storage 216. The input token size may correspond to the length of the query text and may be used to determine the difficulty of the task requested by the user.

The score calculation unit 214 may detect multiple pieces of predefined indicator data and calculate a score for each node by utilizing the multiple pieces of detected indicator data. Here, the multiple pieces of indicator data may include at least one piece of indicator data related to the difficulty of the task requested by the user, indicator data related to the GPU status of each node, and indicator data related to the serving engine status of each node.

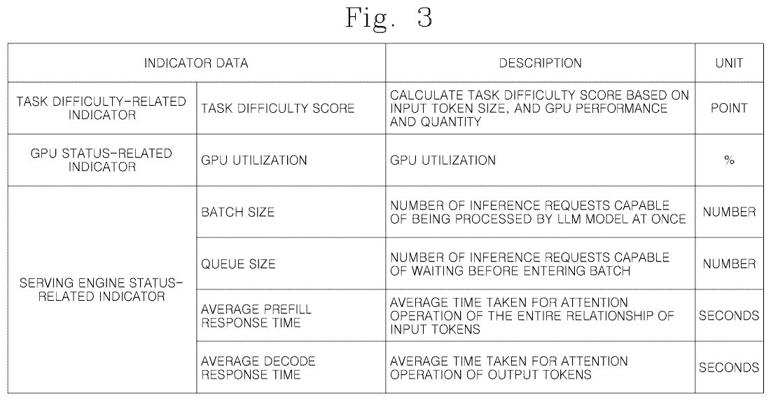

For example, as shown in FIG. 3, a task difficulty score may be used as the indicator data related to task difficulty. In addition, the GPU utilization may be used as the indicator data related to the GPU status. In addition, a batch size, a queue size, an average prefill response time, and an average decode response time may be used as the indicator data related to the serving engine status.

The task difficulty score is an indicator obtained by numerically expressing the difficulty of a task requested by a user, and may be calculated based on information about the input token size corresponding to a user query, information about a predetermined base token size, and information about the performance and quantity of GPUs included in the respective nodes.

The base token size indicates the number of tokens that serve as a criterion for GPU performance in processing input tokens corresponding to a user query. For example, if it is identified that processing efficiency increases only when processing is performed by a high-performance GPU in the case where the number of input tokens exceeds a predetermined number of tokens, the predetermined number of tokens may be configured as the base token size. The base token size may be, but is not limited to, the number of reference tokens used to determine two GPU performance levels, i.e., high-performance level and low-performance level. Therefore, if there are three or more GPU performance levels, two or more base token sizes may be configured.

When the GPU performance is low (e.g., A100), the shorter the user's query, the lower the score needs to be given, and when the GPU performance is high (e.g., H100), the longer the user's query, the lower the score needs to be given. In addition, when the number of GPUs is small, the shorter the user's query, the lower the score needs to be given, and when the number of GPUs is large, the longer the user's query, the lower the score needs to be given. Therefore, the task difficulty score may be defined as shown in Equation 1 below.

$$[ Equation 1 ]$$

$$Score = \frac{\begin{matrix}( base token size - input token size ) * q * ( math . log 2 ( {N}_{gpu} * 2 ) * \\ \frac{q + 1}{2} + ( 5 - math . log 2 ( {N}_{gpu} * 2 ) ) * ( - 1 ) * \frac{q - 1}{2} )\end{matrix}}{base token size}$$

Here, when the GPU performance is high, q=1, when the GPU performance is low, q=−1, base token size is the number of reference tokens, input token size is the number of input tokens, and N_{gpu} is the number of GPUs.

In Equation 1 above, the part (base token size-input token size)*q reflects the performance of the GPU, and the part

$$( math . log 2 ( {N}_{gpu} * 2 ) * \frac{q + 1}{2} + ( 5 - math . log 2 ( {N}_{gpu} * 2 ) ) * ( - 1 ) * \frac{q - 1}{2} )$$

reflects the number of GPUs. In addition, since the corresponding indicator is larger than other indicators in numerical value, the numerator is divided by the base token size for unit correction.

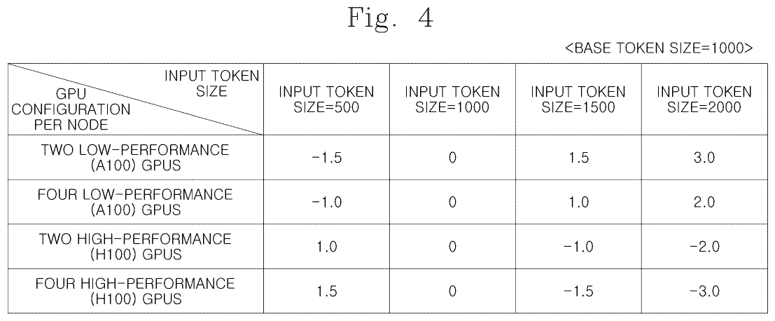

For example, as shown in FIG. 4, in the case where the base token size is set to 1000, the score calculation unit 214 may calculate the task difficulty score depending on the input token size and the GPU configuration for each node using Equation 1 described above. As shown in the drawing, in the case where the input token size is larger than the base token size, the task difficulty score may be calculated lower as the input token size is larger, the GPU performance is higher, and the number of GPUs is larger. On the other hand, in the case where the input token size is smaller than the base token size, the task difficulty score may be calculated lower as the input token size is smaller, the GPU performance is lower, and the number of GPUs is smaller. In addition, as the difference between the input token size and the base token size is larger, the gap between the GPU configurations widens.

The score calculation unit 214 may detect GPU utilization, based on the metric information stored in the storage 216. In addition, the score calculation unit 214 may detect a batch size, a queue size, an average prefill response time, and an average decode response time, based on the metric information stored in the storage 216.

The score calculation unit 214 may detect multiple indicator values for each node.

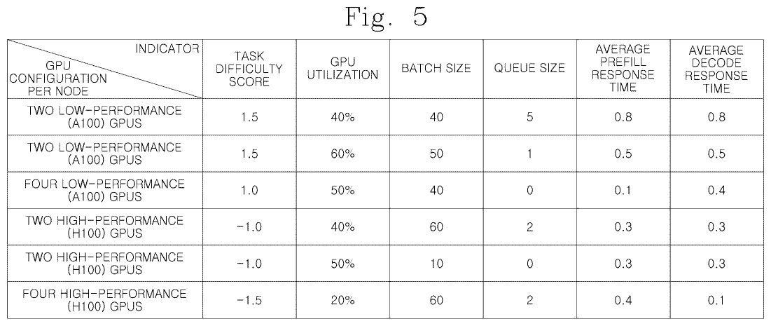

For example, as shown in FIG. 5, in the case where the number of nodes constituting the cluster of the cloud environment is 6, where the input token size is 1500, and where the base token size is 1000, the score calculation unit 214 may detect a task difficulty score (points), GPU utilization (%), a batch size (number), a queue size (number), an average prefill response time (seconds), and an average decode response time (seconds) for each node. Since the unit differs between the respective pieces of indicator data, it is necessary to normalize the indicator data so that a specific indicator is not excessively weighted.

The score calculation unit 214 may correct multiple indicator values using a normalization function such as the Min-Max function or the Softmax function. Hereinafter, the embodiment will be described based on an example of normalizing multiple indicator values using the Min-Max function.

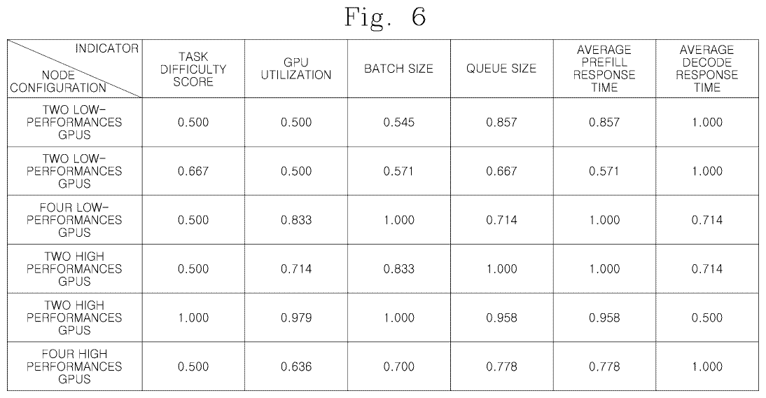

For example, as shown in FIG. 6, the score calculation unit 214 may correct the multiple indicator values such that the minimum value for each indicator becomes 1 and such that the maximum value becomes 2 by applying the Min-Max function thereto.

The score calculation unit 214 may configure priorities for the multiple pieces of indicator data by assigning predetermined weights to the multiple pieces of indicator data.

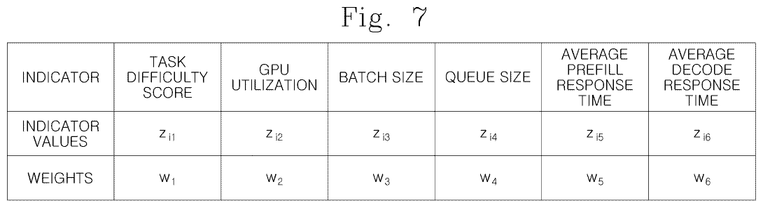

For example, as shown in FIG. 7, the score calculation unit 214 may configure weights for six indicators. Here, the weight has a value between 0 and 1 and may vary depending on the user configuration. If the weight for a specific indicator is 0, the indicator is excluded from score calculation, and the closer the weight for a specific indicator is to 1, the higher the priority for that indicator is configured.

The weight for each indicator may vary depending on various service scenarios.

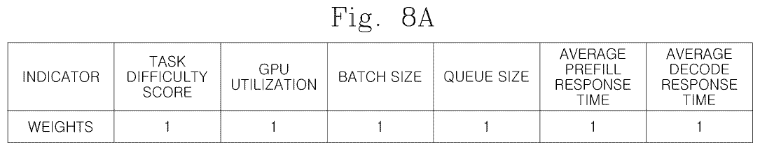

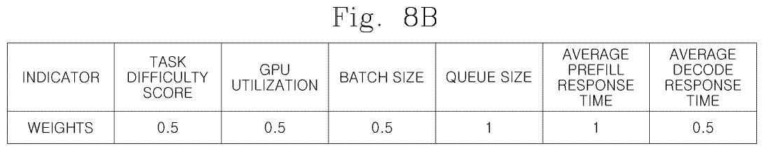

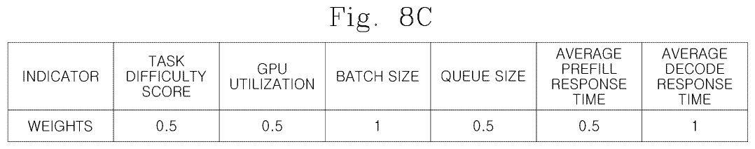

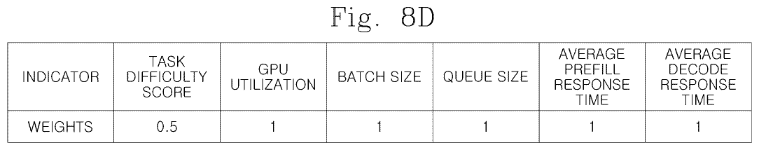

For example, as shown in FIG. 8A in the case of a scenario that equally considers all indicators, the weights for all indicators may be set to 1. In addition, as shown in FIG. 8B, in the case of a scenario that considers the TTFT, one of the service level objectives (SLOs), a higher weight may be given to the queue size and average prefill response time, which are closely related to the TTFT. In addition, as shown in FIG. 8C, in the case of a scenario that considers the TPOT, one of the service level objectives (SLOs), a higher weight may be given to the batch size and average decode response time, which are closely related to the TPOT. In this way, the values of the corresponding indicators may be processed with high priority, which may help attain the service level objectives. In addition, as shown in FIG. 8D, in the case of a scenario where one type of GPU is dominant, it is desirable to configure the weight for the task difficulty score lower than that for other indicators. By adjusting the weight for each indicator depending on various service scenarios, the priority of each indicator may be appropriately adjusted to adaptively respond to various situations.

The score calculation unit 214 may calculate a score for each node using the multiple pieces of indicator data and the weight information assigned to the multiple pieces of indicator data.

As an example, the score (St) for each node may be calculated using Equation 2 below.

$${S}_{i} = {\sum }_{j = 1}^{k} \frac{1}{( \frac{{z}_{ij} - min ( {z}_{j} )}{max ( {z}_{j} ) - min ( {z}_{j} )} ) + 1} \cdot {W}_{j} \qquad [ Equation 2 ]$$

Here, zᵢⱼ is the j indicator value of the i^{th} node, and Wⱼ is the weight for the j indicator.

In Equation 2 above, since it is necessary to preferentially assign tasks to nodes with small indicator values, the score for each node may be calculated using the inverse of each indicator value.

The scheduling unit 215 may select a node to which the task is to be assigned based on the calculated node-specific scores. At this time, the scheduling unit 215 may detect a node with the highest score from among the multiple nodes and select the detected node as the optimal node to which the task is to be assigned.

The scheduling unit 215 may request a task related to the AI service from the selected node 220. The selected node 220 may generate a response corresponding to the user's query using the LLM model and provide the generated response to the scheduling unit 215.

The scheduling unit 215 may obtain an LLM response corresponding to the user's query from the selected node 220 and provide the obtained LLM response to the user terminal 100.

The storage 216 may store data necessary for performing the task scheduling method according to the disclosure. For example, the storage 216 may store information about multiple nodes constituting a cluster. In addition, the storage 216 may store query data obtained from the user terminal 100. In addition, the storage 216 may store information about input tokens corresponding to the user's query. In addition, the storage 216 may store response data corresponding to the user query data.

As described above, the task scheduling apparatus according to an embodiment of the disclosure may efficiently manage the resources of nodes constituting the cluster and stably guarantee the customer's service level objectives by allocating tasks related to AI services to the optimal node, based on task difficulty and/or node-specific status information in a multi-GPU-based or heterogeneous hardware-based cloud environment. In addition, even if a high-performance new model is introduced in line with the advancement of GPU performance, the cloud service provider is able to provide cloud services by using it together with existing models, thereby reducing costs and efficiently utilizing GPU resources. In addition, the cloud service provider may identify the distribution of tasks requested by the user and reflect it to the weights, thereby processing the maximum number of tasks with the minimum number of resources.

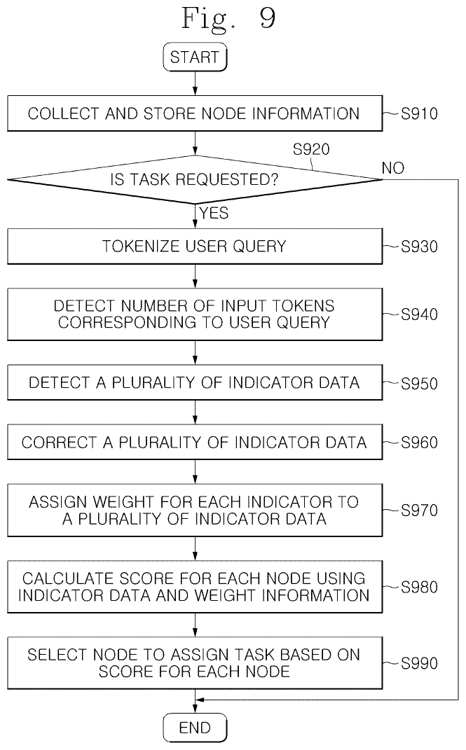

FIG. 9 is a flowchart illustrating a task scheduling method according to an embodiment of the disclosure. A task scheduling method according to this embodiment may be performed by the task scheduling apparatus 210. Although the task scheduling method is illustrated as being divided into multiple steps in the flowchart, at least some of the steps may be performed in a different sequence, combined with other steps and performed together, omitted, or divided into sub-steps and performed, or one or more steps not illustrated may be added and performed.

Referring to FIG. 9, the task scheduling apparatus 210 according to the disclosure may collect information about multiple nodes constituting a cluster of a cloud environment and store the collected information in the storage 216 (S910).

The information about multiple nodes may include information about the types, performance, and quantity of GPUs included in each node, metric information related to the GPU included in each node, and metric information related to a serving engine included in each node. The metric information related to the GPU may include GPU utilization. The metric information related to the serving engine may include at least one of an average prefill response time, an average decode response time, a queue size, and a batch size.

The task scheduling apparatus 210 may identify whether a message requesting a task related to an AI service (hereinafter referred to as a “task request message”) is received from the user terminal 100 (S920). Here, the task related to the AI service may include a task requesting an LLM response to a user query.

If a task request message is received from the user terminal 100 as a result of the identification in step 920, the task scheduling apparatus 210 may tokenize user query data (i.e., query text) (S930).

The task scheduling apparatus 210 may detect the input token size corresponding to the user query (S940). The task scheduling apparatus 210 may store information about the detected the input token size in the storage 216. The input token size may correspond to the length of the query text and may be used to determine the difficulty of the task requested by the user.

The task scheduling apparatus 210 may detect multiple pieces of predefined indicator data for each node (S950). Here, the multiple pieces of indicator data may include at least one of a task difficulty score, which is an indicator related to task difficulty, GPU utilization, which is an indicator related to GPU status, and a batch size, queue size, average prefill response time, and average decode response time, which are indicators related to serving engine status.

The task scheduling apparatus 210 may correct the multiple pieces of indicator data using a normalization function such as the Min-Max function or Softmax function (S960). This is intended to normalize respective pieces of indicator data so that a specific indicator is not excessively weighted because the unit differs between the respective pieces of indicator data.

The task scheduling apparatus 210 may configure priorities for the multiple pieces of indicator data by assigning weights to the respective indicators (S970). Here, the weight for each indicator may vary depending on various service scenarios.

The task scheduling apparatus 210 may calculate a score for each node using the multiple pieces of indicator data and weight information assigned to the multiple pieces of indicator data (S980). At this time, the task scheduling apparatus 210 may calculate a score for each node using Equation 2 described above.

The task scheduling apparatus 210 may select a node to which the task is to be assigned based on the calculated score for each node (S990). At this time, the task scheduling apparatus 210 may detect a node with the highest score from among the multiple nodes and select the detected node as the optimal node to which the task is to be assigned.

The task scheduling apparatus 210 may request a task related to the AI service from the selected node 220. The selected node 220 may generate a response corresponding to the user query using the LLM model and provide the generated response to the task scheduling apparatus 210.

The task scheduling apparatus 210 may obtain an LLM response corresponding to the user query from the selected node 220 and provide the obtained LLM response to the user terminal 100.

As described above, the task scheduling method according to an embodiment of the disclosure may efficiently manage the resources of nodes constituting the cluster and stably guarantee the customer's service level objectives by allocating tasks related to AI services to the optimal node, based on task difficulty and/or node-specific status information in a multi-GPU-based or heterogeneous hardware-based cloud environment.

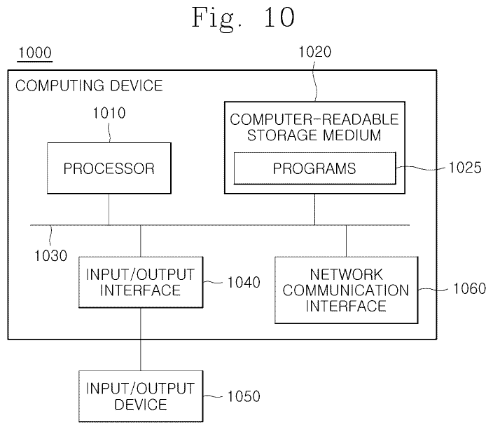

FIG. 10 is a block diagram of a computing device according to an embodiment of the disclosure.

Referring to FIG. 10, the computing device 1000 according to an embodiment of the disclosure may include at least one processor 1010, a computer-readable storage medium 1020, and a communication bus 1030. The computing device 1000 may implement the task scheduling apparatus 210 described above.

The processor 1010 may cause the computing device 1000 to operate according to the exemplary embodiments described above. For example, the processor 1010 may execute one or more programs 1025 stored on the computer-readable storage medium 1020. The one or more programs may include one or more computer-executable instructions, and the computer-executable instructions may be configured to cause, when executed by the processor 1010, the computing device 1000 to perform operations according to the exemplary embodiments.

The computer-readable storage medium 1020 is configured to store computer-executable instructions, program code, program data, and/or other suitable forms of information. The programs 1025 stored on the computer-readable storage medium 1020 include a set of instructions executable by the processor 1010. In an embodiment, the computer-readable storage medium 1020 may be memory (volatile memory such as random-access memory, nonvolatile memory, or a suitable combination thereof), one or more magnetic disk storage devices, optical disk storage devices, flash memory devices, any other form of storage medium capable of being accessed by the computing device 1000 and storing desired information, or a suitable combination thereof.

The communication bus 1030 interconnects the processor 1010, the computer-readable storage medium 1020, and other various components of the computing device 1000.

The computing device 1000 may also include one or more input/output interfaces 1040 that provide interfaces for one or more input/output devices 1050 and one or more network communication interfaces 1060. The input/output interfaces 1040 and the network communication interfaces 1060 are connected to the communication bus 1030.

The input/output device 1050 may be connected to other components of the computing device 1000 via the input/output interface 1040. The exemplary input/output device 1050 may include input devices such as a pointing device (such as a mouse or a trackpad), a keyboard, a touch input device (touchpad or touchscreen), a voice or sound input device, various types of sensor devices, and/or photographing devices, and/or output devices such as a display device, a printer, a speaker, and/or a network card. The exemplary input/output device 1050 may be included within the computing device 1000 as a component that constitutes the computing device 1000, or may be connected to the computing device 1000 as a separate device distinct from the computing device 1000.

The effects of the task scheduling method and the device thereof according to the embodiments of the disclosure will be described below.

According to at least one of the embodiments of the disclosure, there is an advantage of efficiently managing the resources of nodes constituting the cluster and stably ensuring the customer's service level objectives by allocating tasks related to AI services to the optimal node, based on task difficulty and/or node-specific status information in a multi-GPU-based or heterogeneous hardware-based cloud environment.

However, the effects obtainable from the task scheduling method and the device according to the embodiments of the disclosure are not limited to those mentioned above, and other effects that are not mentioned will be clearly understood by those skilled in the art to which the disclosure pertains from the description below.

The disclosure described above may be implemented as a computer-readable code on a medium on which a program is recorded. The computer-readable medium may be a medium that continuously stores a computer-executable program or temporarily stores it for execution or download. In addition, the medium may be a variety of recording means or storage means in the form of a single piece of hardware or a combination of multiple pieces of hardware, and is not limited to a medium directly connected to a computer system, but may also be distributed on a network. Examples of the medium may include magnetic media such as hard disks, floppy disks, and magnetic tapes, optical recording media such as CD-ROMs and DVDs, magneto-optical media such as floptical disks, ROMs, RAMs, flash memories, and the like, which are configured to store program instructions. In addition, examples of other media may include recording media or storage media managed by App Store that distribute applications, or sites or servers that supply or distribute various software. Therefore, the above detailed description should not be construed as limiting the disclosure in all respects and should be considered as examples. The scope of the disclosure should be determined by a reasonable interpretation of the appended claims, and all changes within the equivalent scope of the disclosure are included in the scope of the disclosure.

What is claimed is:

1. A task scheduling method performed by a computing device, the method comprising:
collecting information about a plurality of nodes in a cluster of a cloud environment;
obtaining, from a user terminal, a task related to an artificial intelligence (AI) service provided by the cluster;
detecting a plurality of indicator data for scheduling the task; and
selecting a node to assign the task among the plurality of nodes using the plurality of indicator data.

2. The task scheduling method of claim 1,
wherein the information about the plurality of nodes comprises information about types, performance, and quantity of graphics processing units (GPUs) included in each node, metric information related to the GPUs included in each node, and metric information related to a serving engine included in each node.

3. The task scheduling method of claim 2,
wherein the metric information related to the GPUs comprises GPU utilization, and
wherein the metric information related to the serving engine comprises at least one of an average prefill response time, an average decode response time, a queue size, and a batch size.

4. The task scheduling method of claim 1,
wherein the task related to the AI service is a task requesting a large language model (LMM) response corresponding to a user query.

5. The task scheduling method of claim 4, further comprising:
tokenizing the user query; and
detecting the number of tokens generated through the tokenization.

6. The task scheduling method of claim 5,
wherein the plurality of indicator data comprise at least one of first indicator data related to difficulty of the task, second indicator data related to GPU status of the nodes, and third indicator data related to serving engine status of the nodes.

7. The task scheduling method of claim 6,
wherein the first indicator data comprises a task difficulty score,
wherein the second indicator data comprises GPU utilization, and
wherein the third indicator data comprises at least one of a batch size, a queue size, an average prefill response time, and an average decode response time.

8. The task scheduling method of claim 7,
wherein the task difficulty score is an indicator obtained by numerically expressing the difficulty of the task and calculated based on information about the number of tokens corresponding to a length of the user query, information about a predetermined base token size, and information about performance and quantity of GPUs included in the nodes.

9. The task scheduling method of claim 1, further comprising:
correcting the plurality of indicator data by using a predetermined normalization function.

10. The task scheduling method of claim 1, further comprising:
assigning weights to the plurality of indicator data.

11. The task scheduling method of claim 10,
wherein the selecting comprises:
calculating a score for each node using the plurality of indicator data and weight information assigned to the plurality of indicator data; and
selecting a node to assign the task based on the calculated score for each node.

12. The task scheduling method of claim 11,
wherein the score for each node is calculated using an
$${S}_{i} = {\sum }_{j = 1}^{k} \frac{1}{( \frac{{z}_{ij} - min ( {z}_{j} )}{max ( {z}_{j} ) - min ( {z}_{j} )} ) + 1} \cdot {W}_{j} , \qquad Equation$$
wherein zᵢⱼ is a j indicator value of an i^{th} node, and Wⱼ is a weight for the j indicator.

13. The task scheduling method of claim 4, further comprising:
requesting the task from the selected node;
receiving an LLM response corresponding to the user query from the selected node; and
transmitting the received LLM response to the user terminal.

14. A task scheduling apparatus comprising at least one processor configured to execute a plurality of instructions to perform a plurality of operations and at least one memory configured to store the plurality of instructions,
wherein the plurality of operations comprises:
collecting information about a plurality of nodes in a cluster of a cloud environment;
obtaining, from a user terminal, a task related to an artificial intelligence (AI) service provided by the cluster;
detecting a plurality of indicator data for scheduling the task; and
selecting a node to assign the task among the plurality of nodes using the plurality of indicator data.

15. The task scheduling apparatus of claim 14,
wherein the information about the plurality of nodes comprises information about types, performance, and quantity of graphics processing units (GPUs) included in each node, metric information related to the GPUs included in each node, and metric information related to a serving engine included in each node.

16. The task scheduling apparatus of claim 14,
wherein the task related to the AI service is a task requesting a large language model (LMM) response corresponding to a user query.

17. The task scheduling apparatus of claim 14,
wherein the plurality of indicator data comprise a task difficulty score, GPU utilization, a batch size, a queue size, an average prefill response time, and an average decode response time.

18. The task scheduling apparatus of claim 14,
wherein the plurality of operations further comprises assigning weights to the plurality of indicator data.

19. The task scheduling apparatus of claim 18,
wherein the selecting of the node comprises:
calculating a score for each node using the plurality of indicator data and weight information assigned to the plurality of indicator data; and
selecting a node to assign the task based on the calculated score for each node.

20. A computer-readable storage medium storing one or more programs for performing a task scheduling process by one or more processors of a computing device, the one or more programs comprising instructions for:
collecting information about a plurality of nodes in a cluster of a cloud environment;
obtaining, from a user terminal, a task related to an artificial intelligence (AI) service provided by the cluster;
detecting a plurality of indicator data for scheduling the task; and
selecting a node to assign the task among the plurality of nodes using the plurality of indicator data.
